(19) United States
(12) Patent Application Publication
(10) Pub. No.: US 2007/0158276 A1
(43) Pub. Date: Jul. 12, 2007

(54) Method and Apparatus for Sequenced Batch Advanced Oxidation Wastewater Treatment

(75) Inventor: Stephen P. Markle, Alexandria, VA (US)

Correspondence Address: VENABLE, CAMPILLO, LOGAN & MEANEY, P.C., 1938 E. OSBORN RD, PHOENIX, AZ, 85016-7234, US

(73) Assignee: NAVALIS ENVIRONMENTAL SYSTEMS, LLC, Scottsdale, AZ (US)

(21) Appl. No.: 11/621,202

(22) Filed: Jan. 9, 2007

Related U.S. Application Data
(60) Provisional application No. 60/757,659, filed on Jan. 10, 2006.

(51) Int. Cl. C02F 1/78

(52) U.S. Cl. 210/760; 210/202

(57) ABSTRACT

A batch treatment system that provides wastewater treatment one batch at a time, rather than a continuous flow process. In a basic embodiment, the batch treatment system incorporates two zones: (1) a solids separation zone, and (2) an advanced oxidation zone. More advanced embodiments add a filtration zone after separation and before advanced oxidation. The batch treatment system is particularly useful in applications such as ships because (1) reduced size and weight requirements, (2) the reduction of sludge and organic solids saves space and energy and disposal costs, and (3) the reduction of odors permits shipboard treatment rather than holding in tanks for later discharge.

### CROSS-REFERENCE TO RELATED APPLICATIONS

The present application claims priority to co-pending U.S. provisional patent application entitled “Method and Apparatus for Advanced Oxidation Sequence Batch Process for Wastewater Treatment,” having Ser. No. 60/757,659, filed on Jan. 10, 2006, which is entirely incorporated herein by reference.

### BACKGROUND OF THE INVENTION

1. Field of the Invention

The present invention relates generally to wastewater treatment systems, and more particularly wastewater treatment systems where holding large volumes of sludge for later disposal is difficult. As such, this invention particularly relates to waste water treatment for ships, off-shore structures and platforms other large transportation vehicles, mobile/portable treatment systems (i.e., military support, disaster relief, etc.), remote treatment systems (i.e. highway rest stops, campgrounds, etc.), industrial wastewater treatment, food processing, dairy and other light industrial wastewater treatment applications.

2. Discussion of the Related Art

Land-based wastewater treatment solutions tend to occupy relatively large spaces to effectuate wastewater treatment. Space, however, is a premium on transportation vehicles (like cruise ships), mobile treatment systems (such as used in military support), and remote treatment systems (like campgrounds), as well as other similarly situated treatment scenarios.

Wastewater treatment systems have been disclosed in the following United States or foreign patents: U.S. Pat. No. 3,822,786 (Marschall), U.S. Pat. No. 3,945,918 (Kirk), U.S. Pat. No. 4,053,399 (Donnelly et al.), U.S. Pat. No. 4,072,613 (Alig), U.S. Pat. No. 4,156,648 U.S. Pat. No. (Kuepper), U.S. Pat. No. 4,197,300 (Alig), U.S. Pat. No. 4,214,887 (van Gelder), U.S. Pat. No. 4,233,152 (Hill et al.), U.S. Pat. No. 4,255,262 (O'Cheskey et al.), U.S. Pat. No. 4,961,857 (Ottengraf et al.), U.S. Pat. No. 5,053,140 (Hurst), U.S. Pat. No. 5,178,755 (LaCrosse), U.S. Pat. No. 5,180,499 (Hinson et al.), U.S. Pat. No. 5,256,299 (Wang et al.), U.S. Pat. No. 5,308,480 (Hinson et al.), U.S. Pat. No. 6,811,705 (Puetter), EPO 261822 (Garrett), WO 93/24413 (Hinson) and U.S. Pat. No. 6,195,825 (Jones). None of these references, however, disclose the aspects of the current invention.

### SUMMARY OF THE INVENTION

The invention is summarized below only for purposes of introducing embodiments of the invention. The ultimate scope of the invention is to be limited only to the claims that follow the specification.

Generally, the present invention is incorporated in a batch treatment system for use in a wastewater treatment process (referred to herein as the “batch treatment system”). In a basic embodiment, the batch treatment system incorporates a solids separation zone and an advanced oxidation zone. The solids separation zone includes a clarifier, a flocculator, and an ozone infusing subsystem and is in periodic fluid communication with the advanced oxidation zone. The advanced oxidation zone includes a reactor housing fluidized media and a recirculation subsystem that incorporates the use of ultraviolet light and ozone. Other embodiments include the use of filtration and ultrafiltration. In operation, wastewater does not continuously flow through the solids separation zone or the advanced oxidation zone but is treated one batch at a time before passing to the next zone.

One advantage of the batch treatment system is that it requires virtually no chemical additions and no chlorine.

Another advantage of the batch treatment system is no biological sludge production.

Another advantage of the batch treatment system is that it can be configured for a small footprint.

Another advantage of the batch treatment system is that it can be configured for use in small vessels (i.e., 1 to 150 people).

Another advantage of the batch treatment system is that it produces treated effluent minutes after start-up.

Another advantage of the batch treatment system is that it can be configured to be compact in size, simple in design, inexpensive to operate, skid mounted, operate in a marine environment, and is hatchable through most common ship passages.

Another advantage of the batch treatment system is that it permits real-time effluent monitoring.

Another advantage of the batch treatment system is that it is simple to operate as well as it has low operating and maintenance costs.

Another advantage of the batch treatment system is that is can treat blackwater and graywater wastewater to legally dischargeable environmental standard.

Another advantage of the batch treatment system is that is can be used use in the marine environment aboard ships and offshore structures,

Another advantage of the batch treatment system is that it is equally useful in land based stationary and mobile applications (i.e. truck or trailer mounted).

The description of the invention that follows, together with the accompanying drawings, should not be construed as limiting the invention to the example shown and described, because those skilled in the art to which this invention pertains will be able to devise other forms thereof within the ambit of the appended claims.

### BRIEF DESCRIPTION OF THE DRAWINGS

FIG. 1 illustrates a preferred flow diagram for a batch treatment system embodiment.

FIG. 2 illustrates a front elevation of a batch treatment system embodiment.

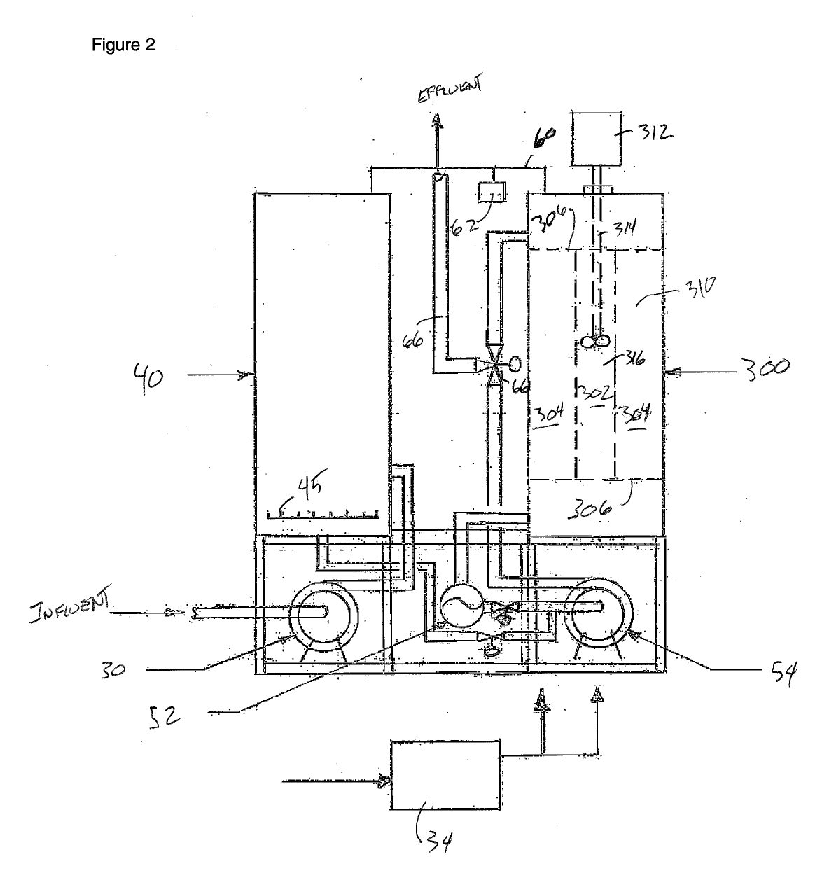

FIG. 3 illustrates a basic embodiment of the system (i.e., no filtration).

FIG. 4 illustrates a medium treatment embodiment of the system with filtration

FIG. 5 illustrates an advanced treatment embodiment of the system using ultrafiltration.

FIG. 6 illustrates a preferred stirred advanced oxidation batch reactor.

### DESCRIPTION OF THE PREFERRED EMBODIMENT

The descriptions below are merely illustrative of the presently preferred embodiments of the invention and no limitations are intended to the detail of construction or design herein shown other than as defined in the appended claims. In this specification, the term “advanced oxidation” refers to a process that typically involves the generation and use of the hydroxyl free radical (OH⁻) as a strong oxidant to destroy compounds that cannot be oxidized by conventional oxidants such as oxygen, ozone, and chlorine.

The batch treatment system can be embodied in at least three different levels of treatment. A basic system embodiment 100 would comprise a solids separation zone 110 and an advanced oxidation zone 140. A medium treatment embodiment 150 would comprise a solids separation zone 110, a filtration zone 120, and an advanced oxidation zone 140. An advanced treatment embodiment 160 would comprise a solids separation zone 110, a filtration zone 120 that includes an ultrafiltration unit 130, and an advanced oxidation zone 140. Embodiment selection is based upon quality of treated water desired. For example, the basic system embodiment 100 provides minimal regulatory compliance for discharge into the environment, and the advanced treatment embodiment 160 provides a high quality effluent suitable for reuse as technical water (wash down, laundry, flushing systems).

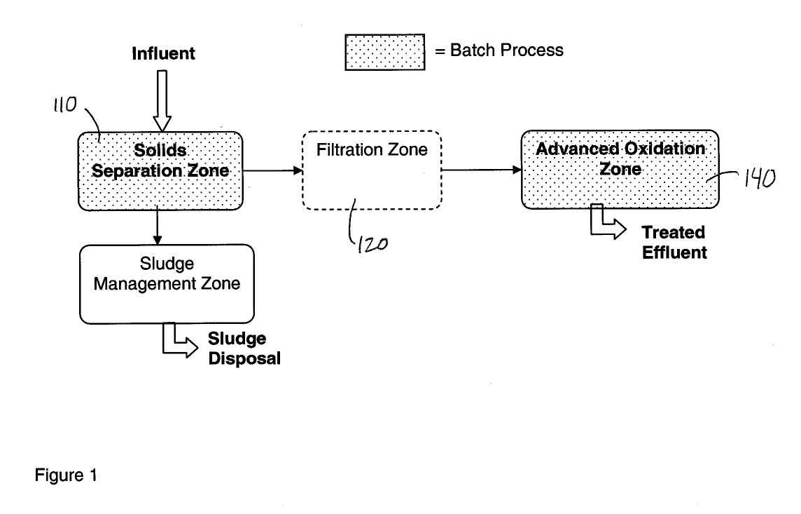

The batch treatment system processes wastewater using a sequenced batch process. In a sequence batch process, flow is neither continuously entering nor leaving the system (i.e. flow enters, is treated, and then is discharged to the next step). FIG. 1 provides a functional diagram of an embodiment of the batch treatment system. Batch processes are used in the solids separation zone 110 and advanced oxidation zone 140. The filtration zone 120 is a flow through process moving wastewater from one batch treatment process to the next. The filtration zone 120 is only used in the medium treatment embodiment 150 and the advanced treatment embodiment 160. A filtration zone 120 it is not used in the basic system embodiment 100.

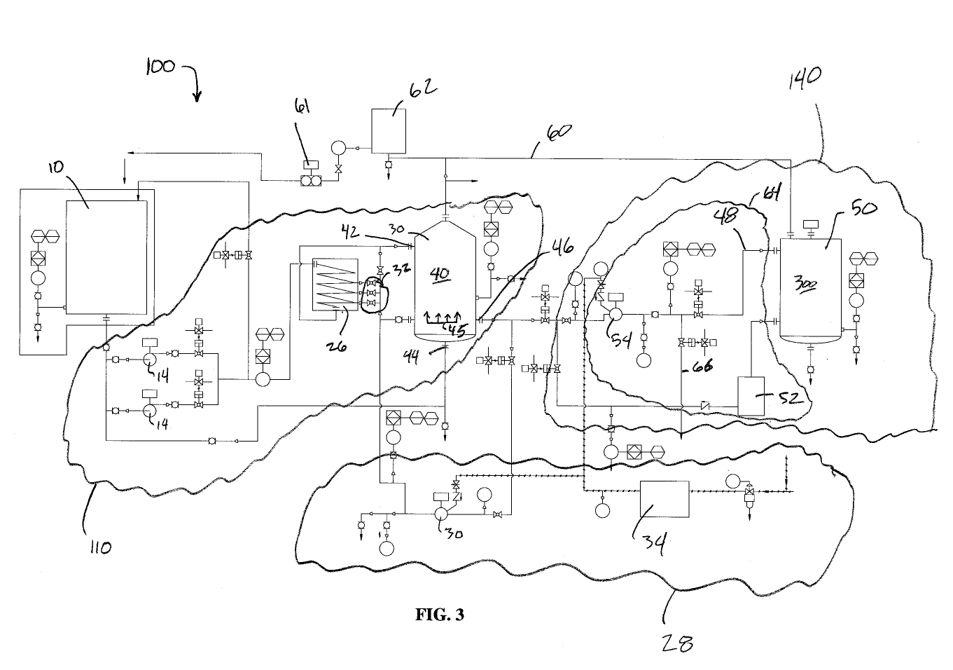

As shown in FIG. 3, the basic batch treatment system 100 treats wastewater as follows. Wastewater is initially held in a storage tank 10. From the storage tank 10, wastewater is transferred to a solids separation zone 110. There are multiple ways to separate solids. For the batch treatment system, however, it is preferred that the solids separation zone 110 comprises a pump 14, a flocculator 26, a clarifier 30, and an ozone infusing subsystem 28 in fluid communication with each other. The preferred ozone infusing subsystem 28 would include a gas dissolving pump 30 and an ozone generator 34.

The pump 14, preferably a macerating grinder pump, transfers the wastewater from the storage tank 10 to the flocculator 26. In doing so, the pump 14 can homogenize the wastewater to an optimum particle size compatible with the clarifier 30 and fills the clarifier 30 to a predefined level. An example of a macerator pump 26 for a 5-gpm system is manufactured by Barnes, model number DGV2042L.

Just prior to the clarifier, a small mixture of ozone gas and air 32 is streamed into the wastewater as it passes through the flocculator 26 by the gas-dissolving pump 30. An ozone generator 34 can be utilized to provide the ozone. An example of a gas-dissolving pump 30 is made by Nikuni, model M25NPD-15Z. This step facilitates separation since the air will adhere to particles suspended in the wastewater, causing them to become positively buoyant. Alternatively a coagulant, preferred is a solution of aluminum chlorohydrate, may be added by dosing pump or other means to attain an optimum concentration (roughly 30-ppm) to assist flocculation and coagulation of solids.

While many types of clarifiers are available, the preferred clarifier is a stainless steel hydraulic-lift dissolved air flotation device having a cone-shaped top, which is referred to in this specification as a solids separator 40. Effluent from the flocculator 26 flows into the solids separator 40 at the inlet 42.

In the solids separator 40, some of the solids in the wastewater entering inlet 42 have an initial positive buoyancy causing them to float to the top, while the balance is maintained in solution and those that higher density begin to fall to the bottom of the solids separator 40. A stream of wastewater is removed from the solids separator 40 at a side outlet 46, infused with ozone gas by the gas-dissolving pump 30, recirculated to the flocculator 14, and then back into the solids separator 40 at inlet 42. This continual addition of ozone reacts the organic solids material in the solids separator 40 increasing its density while decreasing the total weight of solids material.

Alternatively, this action may be augmented by introducing recirculated water with dissolved ozone directed into pipe diffusers 45 (source of this water is same as for the flocculator 26) near the bottom of the solids separator 40. When released from the pipe diffusers, dissolved ozone forms very fine bubbles that move upwards, imparting an upward velocity to the fluid. As ozone contacts solid material it tends to agglomerate onto its surface imparting a slight positive buoyant force and begins to oxidize organic material. This combination of upward fluid velocity and positive buoyancy floats solids to the surface.

Continual addition of aerated and ozonated recirculated water into the solids separator 40 through the flocculator 26, and alternatively the pipe diffusers 45, continuously mixes the material within the solids separator 40 continually oxidizing and reacting the organic material. At periodic intervals the recirculation stream is stopped and the solids separator 40 enters a period of quiescence. During this time the reacted solids tend to sink to the bottom of the device leaving a small blanket of floating solids and foam at the top and a well defined clarified liquor zone in the middle. Experiments have shown that between 70 and 80% of the wastewater may be decanted as clarified liquor when using this method. The clarified liquid is decanted from the solids separator 40 from a side outlet 46 and directed for further treatment.

The remaining solids and floating material in the solids separator 40 is either retained within the solids separator 40 for further processing, or pumped via bottom outlet 44 to storage tanks for subsequent disposal. In the case of a 5-gpm system (nominal, flow averaged over a twenty four hour period) an example of a solids separator 40 is a two-foot diameter 316 stainless steel tank having a volume of approximately 118-gallons with a design hydraulic residence time of 23 minutes available from Navalis Environmental Systems as part number TK24-004-01.

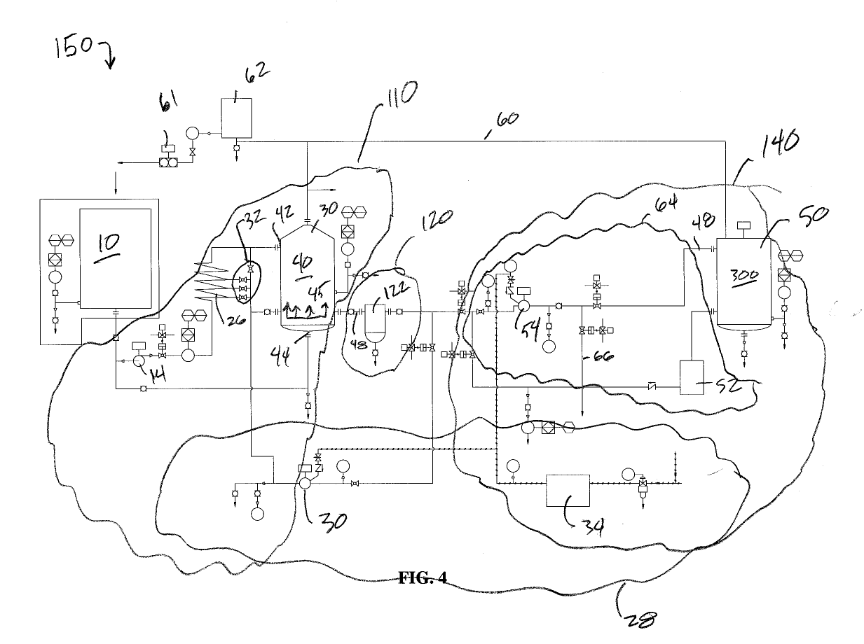

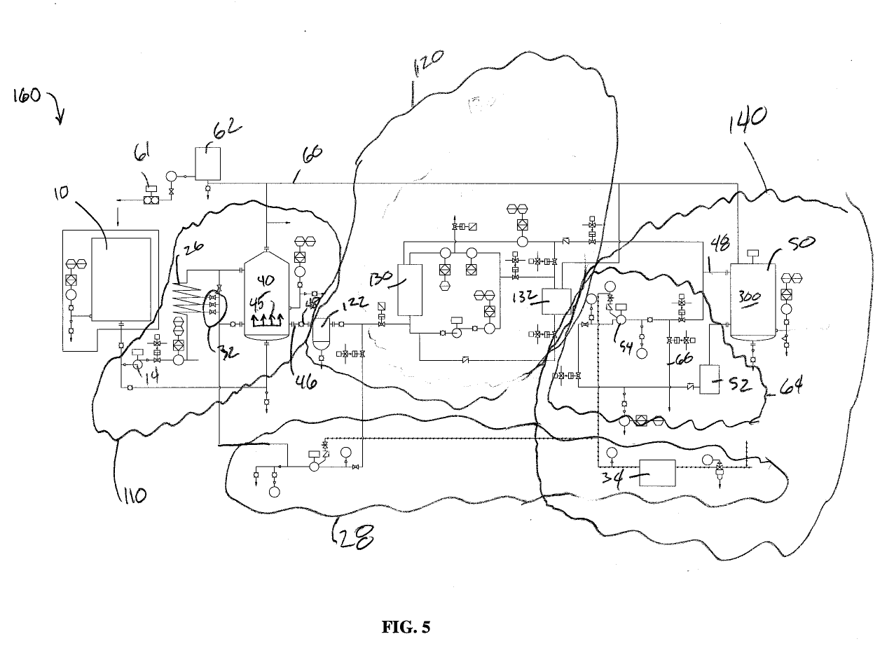

In the basic system embodiment 100, wastewater (clarified liquor 48) is pumped from the solids separation zone 110 to the advanced oxidation zone 140. In the medium treatment embodiment 150, wastewater (clarified liquor 48) is pumped from the solids separation zone 110 through the filtration zone 120 before being directed to the advanced oxidation zone 140 as shown in FIG. 4. In the advanced treatment embodiment 160, wastewater (clarified liquor 48) is pumped from the solids separation zone 110 through the filtration zone 120, which includes an ultrafiltration unit 130, before being directed to the advanced oxidation zone 140 as shown in FIG. 5.

After the clarified liquor 48 empties from the solids separator 40, the hydraulic separator 40 is then refilled from the storage tank 10 as described above and the batch process begins again.

For the medium treatment embodiment 150, the preferred filtration zone 120 comprises an ozone resistant tubular backwashable filter 122, such as model AQM 30 manufactured by Wastewater Resources Incorporated. For the advanced treatment embodiment 160, it is preferred that filtration zone 120 additionally comprise an ultrafiltration unit 130 and a permeate flush tank 132. It is preferred that the ultrafiltration unit 130 be pressure fed ozone resistant tubular ceramic ultrafiltration membranes, such as the Kerasep Series manufactured by Novasep Orelis. System capacity may be increased by adding additional modules. The ultrafiltration unit 130 should be periodically flushed with water produced by the ultrafiltration unit 130 and stored in the permeate flush tank 132.

The preferred advanced oxidation zone 140 comprises a reactor vessel 50, an ultraviolet (UV) unit 52, and an ozone dissolving pump 54. Within the reactor vessel 50 are neutrally buoyant media 310. The purpose of the media 310 is to provide sufficient surface area for the interaction and oxidation of dissolved ozone and soluble and insoluble organic material.

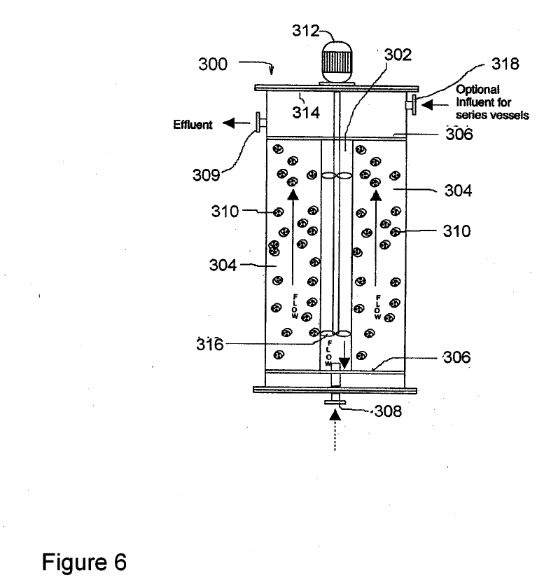

FIG. 6 illustrates a preferred reactor vessel 50, a stirred reactor 300. Referring to FIG. 6, the stirred reactor 300 comprises two cylindrically shaped chambers: a cylindrical acceleration chamber 302 and a fluidized media chamber 304. The two chambers are mounted coaxially with respect to each other (i.e., one inside the other). Two washer-shaped perforated plates 306 on either end cap the fluidized media chamber 304. One perforated plate is mounted near the top of the stirred reactor 300 and the other near the bottom. The volume between the perforated plates 306 houses fluidized media 310. These upper and lower perforated plates 306 hold the fluidized media 310 in place and away from inlet and outlet ports. It is preferred that the perforations be sized to allow maximum flow while retaining the fluidized media 310 between perforated plates 306.

The cylindrical acceleration chamber 302 is smaller in cross section and mounted between the perforated plates 306. The preferred stirred reactor 300 has inlet ports 308 and outlet ports 309 for admitting and exhausting the liquid. At the top of the stirred reactor 300, a mixer 312 with a shaft 314 containing multiple blades 316 passes down though the cylindrical acceleration chamber 302. The mixer 312 moves fluid in the cylindrical acceleration chamber 302 down and out to the fluidized media chamber 304 through the bottom perforated plate 306. After passing through the bottom perforated plate 306, water moves up through the fluidized media chamber 304 and then back into the top of cylindrical acceleration chamber 302 to begin the process again.

Ozone enriched fluids react with dissolved ozone and tiny, outgassed ozone bubbles which have formed on the fluidized bed, walls of the chamber, and float freely within the chamber. This enhanced batch oxidation reactor allows for advanced treatment in a small space. The stirred reactor 300 can be used alone, in series or in parallel. When connected in series, the outlet port 309 of one stirred reactor 300 can be connected to the series inlet port 308 if the second stirred reactor 300. A suitable example of a preferred stirred reactor 300 for a 5-gpm unit is a two-foot diameter 316 stainless steel tank having a volume of approximately 118-gallons with a design hydraulic residence time of 23 minutes available from Navalis Environmental Systems as part number TK24-003-01.

Water is continuously pumped out of the stirred reactor 300 and through an ultraviolet light disinfection unit, or UV unit 52. A medium pressure, high intensity unit produces polychromatic light, which destroys residual organic material, and further disinfects the wastewater. The UV unit 52 preferably features an automatic cleaning wiper (as controlled by a PLC). Light produced by the UV unit also enhances the advanced oxidation reaction by transforming any residual ozone into fast reacting species, such as hydrogen peroxide and hydroxyl radicals further consuming any residual organic material. In the preferred 5-gpm variant of this system, an example of a suitable UV unit 52 is manufactured by Hyde Marine, part number InLine 20.

Following the UV unit 52, water is directed to a gas dissolving pump 54 where ozone gas is dissolved in the water and it is directed back into the stirred reactor 300. This recirculation loop 64 for advanced oxidation zone 140 is continuous throughout the batch process.

After the design hydraulic residence time has been reached, a discharge valve 66 is opened draining the stirred reactor 300. An alternate embodiment would control the discharge cycle through automatic measurement of effluent quality by comparison of oxidation-reduction potential and fluid turbidity. Treated water is then either pumped directly overboard, or pumped to onboard ship storage tanks for eventual discharge. After the stirred reactor 300 is emptied, the batch being treated in the solids separator 40 is pumped into the stirred reactor 300 to begin the process anew.

An ozone generator 34 produces gaseous ozone. For the 5-gpm preferred embodiment, Pacific Ozone Model SGA24 with a rating of sixty grams/hour is used. If available, the preferred source of air to the ozone generator is from ship service oil free compressed air. However, if not available, a self-contained air compressor can be provided as an integral part of the ozone generator.

An ozone gas destruction system 60 is provided to decompose residual ozone gas to oxygen through catalytic action. Using a blower 61 this system draws a slight vacuum from the top of tanks 40 and 300 and draws the gases through an ozone destruct device 62 before discharging into an installed ventilation system.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

What is claimed is:

1. A batch treatment system for use in a wastewater treatment process, the batch treatment system comprising:
a solids separation zone and an advanced oxidation zone, wherein the solids separation zone is in periodic fluid communication with the advanced oxidation zone,
the solids separation zone comprising a clarifier, a flocculator, and an ozone infusing subsystem,
the advanced oxidation zone comprising a reactor housing fluidized media
wherein wastewater does not continuously flow through the solids separation zone or the advanced oxidation zone but is treated one batch at a time before passing to the next zone.

2. The batch treatment system of claim 1 wherein the ozone infusing subsystem comprises a recirculation line, an ozone generator and a gas dissolving pump.

3. The batch treatment system of claim 1 wherein the reactor further comprises a blade for mixing liquids.

4. The batch treatment system of claim 1, the batch treatment system further comprising a filtration zone in fluid communication with the solids separation zone and the advanced oxidation zone, wastewater flowing through the filtration zone after the solids separation zone and before the advanced oxidation zone.

5. The batch treatment system of claim 4 wherein the filtration zone comprises filtration and ultrafiltration.

6. A method for batch treatment of wastewater comprising the acts (steps) of:
separating a batch of wastewater,
transferring the batch of separated wastewater to an advanced oxidation zone,
treating the batch of separated wastewater with advanced oxidation.

7. The method for treating wastewater of claim 6, wherein the transferring step includes a filtration step of passing the batch of separated wastewater through a filtration unit before the advanced oxidation zone.

8. The method of claim 7 wherein the filtration step includes filtration followed by ultrafiltration.

9. The method for treating wastewater of claim 6, wherein the separating step comprises a clarifier, a flocculator, and an ozone infusing subsystem.

10. The method of claim 7, wherein the treating step comprises a reactor housing fluidized media.

11. The method of claim 10 wherein the reactor is a stirred reactor having a blade for mixing liquids.
